(19) United States
(12) Patent Application Publication
(10) Pub. No.: US 2012/0136746 A1
(43) Pub. Date: May 31, 2012

(54) Systems and Methods for Conducting On-Line Auctions

(76) Inventor: William W. Lange, Corona Del Mar, CA (US)

(21) Appl. No.: 13/369,533

(22) Filed: Feb. 9, 2012

Related U.S. Application Data
(63) Continuation-in-part of application No. 12/275,277, filed on Nov. 21, 2008.
Application No. 12/275,277 is a continuation-in-part of application No. 11/088,059, filed on Mar. 23, 2005, now abandoned.

(51) Int. Cl. G06Q 30/08

(52) U.S. Cl. 705/26.3

(57) ABSTRACT

The present invention includes systems and methods for conducting an auction over a computer network, the computer network being connectable to a plurality of computers, the method comprising storing on a network accessible storage device descriptions of lots with or without common characteristics to be auctioned; scheduling via a network accessible computer a bid deadline; transmitting via the network accessible computer the bid deadline to the computers connected to the computer network; allowing a bid to be placed from one of the computers connected to the computer network before the bid deadline; defining a bid deadline extension triggering condition dependent on at least the number of bids being placed before the bid deadline; determining whether the extension triggering condition has been met; and extending the bid deadline when the extension triggering condition is met for an individual lot or simultaneously for a plurality of lots.

### CROSS REFERENCE TO RELATED APPLICATIONS

This application is a continuation-in-part application of pending U.S. patent application Ser. No. 12/275,277 filed Nov. 21, 2008. This application is also a continuation in part of U.S. patent application Ser. No. 11/088,059 which was filed on Mar. 23, 2005.

### STATEMENT REGARDING FEDERALLY SPONSORED RESEARCH OR DEVELOPMENT

### None

### TECHNICAL FIELD

The present invention relates to various advertising, marketing, and sales systems and methods, and in particular on-line marketing systems and on-line sales through auctions.

### BACKGROUND

A number of auctioning techniques exists, including sealed, outcry, English, Dutch, and closed auctions. The traditional outcry auction is the simplest form, and has been around for hundreds of years. An auctioneer is positioned in front of a group of bidders and solicits bids for a particular item, raising the price each time until no one else is prepared to outbid the highest bidder. The gavel falls and the highest bidder is declared the buyer of the item.

There are inherent disadvantages in an outcry auction. The bidders must in most cases be present to bid, or they must trust their bidding to another person who is present on their behalf. The bidders may only have a few seconds to make a decision; and, there can be confusion in the heat of the moment, and bids may be missed. Internet auctions have minimized the number of bids missed or lost provided all the computers and networks involved are working correctly. Internet auctions, such as the system disclosed in US Patent Application Publication Number 2002/0174060 by Friedland et. al., have also allowed people to bid on an item despite being remote from the location of the auction. However, the very complexity of an internet-based auction system, including the system disclosed in Friedland et al., can cause technical issues including loss of connectivity and data loss, preventing bidders from placing the bids.

U.S. Pat. No. 7,152,043 (Alaia et al) appears to be designed to stop online bidding in the event of a computer or other problem, hold the auction in “pending” status, and then increase the length of the auction by a predetermined amount of time. Specifically, in Alaia, an auction is placed into a “pending” status until the technical issues have been resolved. The auctions are restarted at a later time, which can result in similar auctions ending very close to each other. In Alaia, systems are configured to offer extensions of later auctions so they finish a sufficient time apart for bidders to react. Alaia strives to prevent auctions from ending simultaneously or in close proximity.

In both traditional and current auction methods, bidding activity generally tends to increase as the scheduled bidding deadline approaches. It is generally possible to achieve a better auction price if the auction is allowed to continue as long as bids continue to come in. When traditional and current auction methods close the auction even if bids continue to come in, they prevent another bidder from having the opportunity to hid a higher auction price. Thus, traditional and current auction methods including the systems disclosed in both Friedland and Alaia have limited abilities to maximize the auction price.

The system in Alaia may be designed to extend the bidding deadline, but it may only extend the bidding deadline due a technical issue. What triggers the extension of the bidding deadline in Alaia is not dependent on the bidding actions by the bidders. Thus, if there are no technical issues and the system works fine, the system in Alaia may not extend the bidding deadline even if the bids continue to come in. An auction system designed to maximize the auction price is desired.

Another disadvantage with traditional and current auction methods, including the systems disclosed in both Friedland and Alaia, is that they force a bidder who only wishes to buy one item but can choose between several to make decisions on only the items as they are brought up to the auction by the auctioneer. For instance, a bidder may be interested in several lots that are somewhat homogeneous or interchangeable in nature or location, such as houses in a particular neighborhood or town. With traditional and current auction methods, including the systems disclosed in both Friedland and Alaia, the bidder may successfully purchase the first lot only to find that the bidder could have purchased the second lot for a better price or value. Alternatively, the bidder may allow the first lot to be purchased by someone else only to find that the second lot was bid to a higher price by other bidders than the bidder was willing or able to pay. Systems and methods that group similar auction items and allow the auctions for these similar items to end simultaneously are desired, as they may be able to assist buyers in making the right purchasing decision and they may maximize the final auction price, which consequently benefits the auction sellers and auctioneers.

### BRIEF SUMMARY

Accordingly, the present invention includes systems and methods for conducting an auction over a computer network, the computer network being connectable to a plurality of computers, the method comprising storing on a network accessible storage device a description of a lot to be auctioned; scheduling via a network accessible computer a bid deadline; transmitting via the network accessible computer the bid deadline to the computers connected to the computer network; allowing a bid to be placed from one of the computers connected to the computer network before the bid deadline; defining a bid deadline extension triggering condition dependent on at least the number of bids being placed before the bid deadline; determining whether the extension triggering condition has been met; and extending the bid deadline when the extension triggering condition is met.

The present invention also includes a method of conducting an auction over a computer network, the computer network being connectable to a plurality of computers, the method comprising storing on a storage device connected to the computer network descriptions of various lots to be auctioned; defining lot characteristics for at least one lot category; selecting from the lots to be auctioned lots that fit the predefined lot characteristics; auctioning over the computer network the lots that fit the predefined lot characteristics; and scheduling a bid deadline for accepting bids, the bid deadline for each of the selected lot being the same.

The present invention further includes a method for conducting an auction over a communications network, the method comprising providing on a network-accessible computer a plurality of lots to be auctioned; providing on the network-accessible computer at least one category of lots; establishing on a computer program at least one criterion for the category of the lots to be auctioned; selecting using the computer program at least one lot that meets the at least one criterion; auctioning at the same time a plurality of lots that are selected to be in one category via the communications network; setting a specific bid deadline for each of the plurality of lots that are selected to be in one category; defining a condition that would require the bid deadline for at least one of the plurality of lots to be extended; determining using the computer program and based on the condition whether to extend the bid deadline for at least one of the plurality of lots; and if the bid deadline for the at least one of the plurality of lots is determined to be extended, extending all the bid deadlines of all the plurality of lots in the same category to be substantially the extended bid deadline which had been determined.

### BRIEF DESCRIPTION OF THE DRAWINGS

FIG. 1 is substantially a schematic diagram of the components of an embodiment of an auction system of the present invention.

FIG. 2 is substantially a front view of a computer configured to be used by a bidder in using certain embodiments of the present invention.

FIG. 3 is substantially a schematic diagram of the components of the bidder's computer from FIG. 2.

FIG. 4 is substantially a schematic diagram of a server computer and its components that may be used in the system or method of the present invention.

FIG. 5A is substantially a flowchart of an embodiment of an auction method of the present invention.

FIG. 5B is substantially a flowchart of another auction method embodiment of the present invention.

FIG. 6 is substantially a front view an embodiment of a current auction events web page of the present invention.

FIG. 7 is substantially a front view of an embodiment of a portfolio page of the present invention.

FIG. 8 is substantially a front view of an embodiment of a property profile page of the present invention.

FIG. 9 is an illustration of a property profile page where a property is being auctioned in an online format wherein the details of a property for sale and bidder identities, bid amounts and the bid history are disclosed.

FIG. 10 is substantially an illustration of a situation where the number of bids does not exceed a predetermined threshold value at a bid deadline and further showing the system consequently not extending the bid deadline.

FIG. 11 is substantially an illustration of a situation where the number of bids exceeds a predetermined threshold value at a bid deadline and further showing the system consequently extending the bid deadline.

FIG. 12 illustrates the start and end times for the bidding for four different lots.

FIG. 13 illustrates the adjusted start and end times for bidding for four different lots in Universal Last Call.

FIG. 14 is substantially a flowchart showing portions of an embodiment of a method of conducting an on-line auction of the present invention.

### DETAILED DESCRIPTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. When discussing the manner of operation and use of certain embodiments of the present invention or any of the flowcharts included in the present application, it is to be understood that the order in which the steps are presented is not limited to any particular order and does not necessarily imply that they have to be performed in the order presented. It will be understood by those of ordinary skill in the art that the order of these steps can be rearranged and performed in any suitable manner. It will further be understood by those of ordinary skill in the art that some steps may be omitted or added and still fall within the spirit of the invention. Also, it is to be understood that the phraseology and terminology employed herein are for the purpose of description and should not be regarded as limiting.

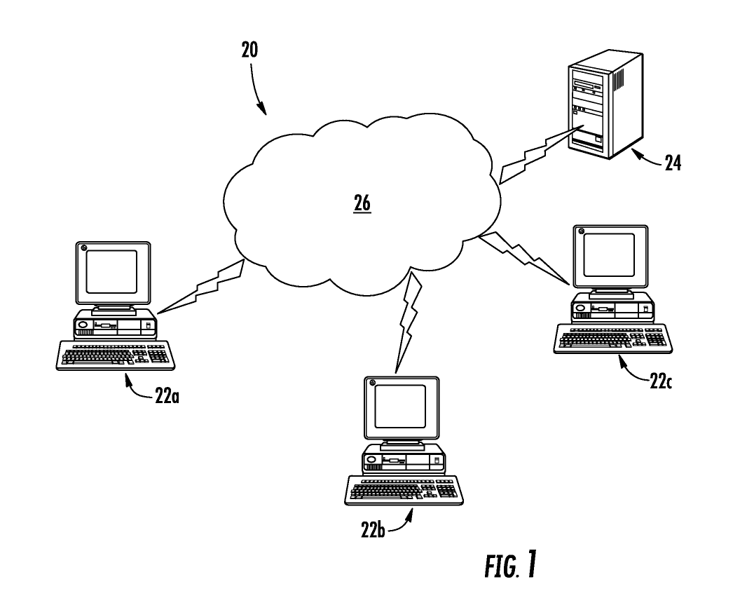

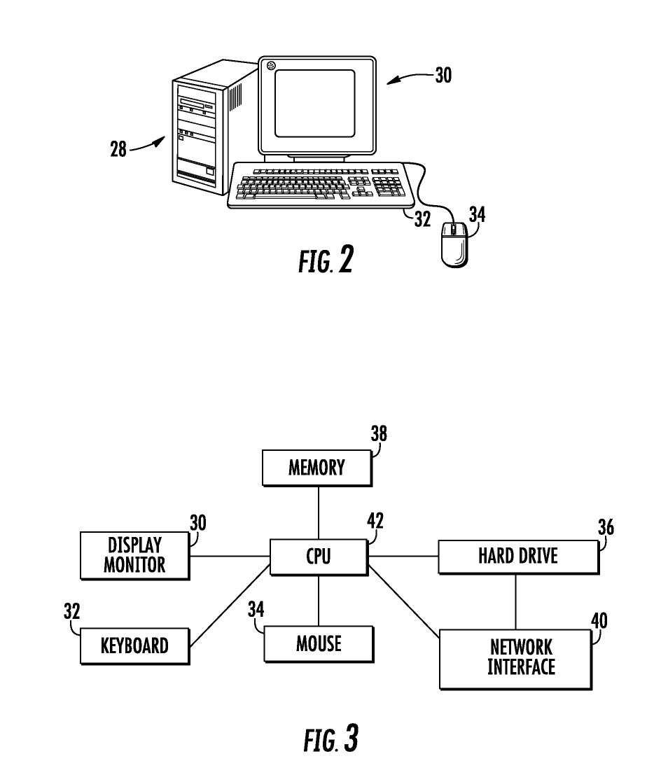

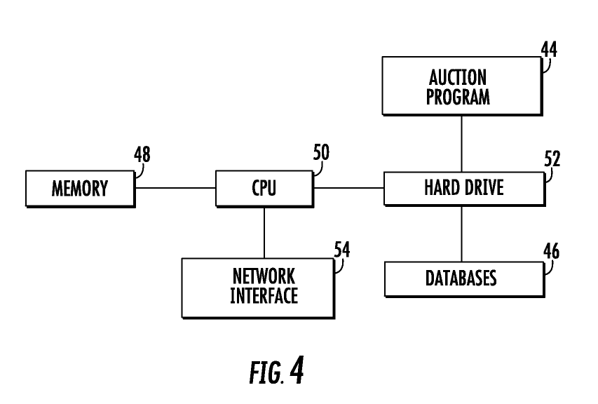

The present invention includes various systems and methods for conducting an on-line auction. As shown in FIG. 1, an embodiment of a system 20 that may conduct an on-line auction method of the present invention preferably includes a plurality of bidders' computers 22a, 22b, and 22c connected to a server computer 24 via a network, such as the internet 26. Referring now to FIGS. 2 and 3, each bidder's computer 22a, 22b, or 22c may include a central processing unit or CPU 42, hard drive 36, memory 38, and network interface 40 in a case 28, a display device 30, and input devices, such as a keyboard 32 and a mouse 34. In the hard drive 36, a web browser is preferably stored and is preferably configured to request for the webpages of the on-line auction website and display the webpages for a user.

The web browser preferably is configured to communicate with a web server, which may reside in the server computer 24. The server computer 24 preferably provides webpages to the bidders' computers and allows the users of the bidders' computers to participate in bidding via an auction program 44 (FIG. 4), which may be stored therein. The server computer 24 may further act as a database server and include various databases 46 to keep track of bidding statistics and information that may be essential to operating the on-line auction, such as bidder information, auction item information, and detailed information about on-going and past auctions. FIG. 4 provides a schematic representation of the components of a server computer to run an auction web site, make available information about each auction and auction items, and run the database necessary that contains the bidder, auction item and auction information to run the auction web site. The components of the server computer may include a server memory 48, a server CPU 50, a server storage device such as hard drive 52, and a network interface 54.

The server computer 24 and the plurality of bidders' computers 22a, 22b, or 22c, although not necessarily at the same location, are preferably connected to an electronic network that may be the Internet as demonstrated in FIG. 1. The network preferably allows electronic communication between the server computer 24 and plurality of bidders' computers so that bidders' computers may display current auction item and bid information, and as necessary communicate to the server, bidders' bids on specific items and the progress of the auction.

### Embodiment of an Auction Method of the Present Invention

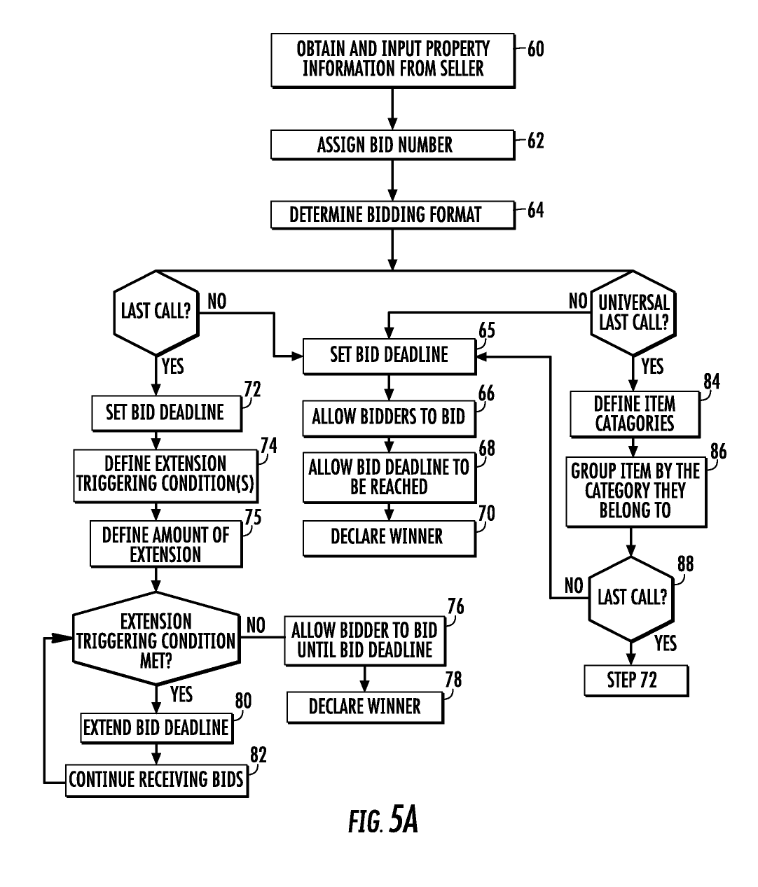

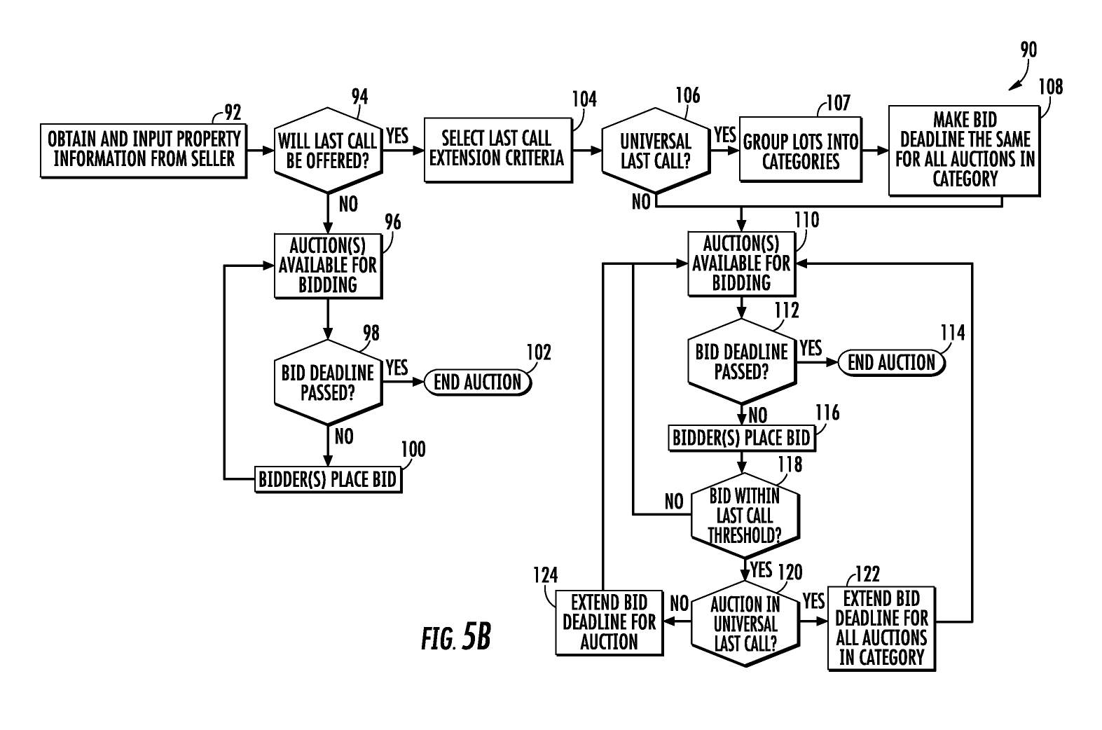

Referring now to FIG. 5A, the auction program 44 stored in a computer from the system of the present invention, such as the server computer 24, is preferably configured to execute the following steps. At step 60, the system preferably obtains and enters information about the property to be auctioned. Next, a bid number is preferably assigned to the property (step 62), and the system preferably determines the bidding format (step 64). The bidding format may be as follows: scaled or open bidding, with or without Last Call feature, with or without Universal Last Call Feature, or their combinations, such as sealed with Last Call and with Universal Last Call, open bidding with Last Call and with Universal Last Call, and the like. The terms Last Call and Universal Last Call are explained further below. If the format does not include the Last Call or the Universal Last Call feature, the auction preferably begins by setting a bid deadline (step 65) and allowing bidders to bid on a property (step 66). The auction preferably continues until the bid deadline is reached (step 68). Once the bid deadline is reached, a winner is preferably declared (step 70).

If the format includes the Last Call feature, in addition to an initial bid deadline preferably being set (step 72) an extension triggering condition(s) may then be defined (step 74). The extension triggering condition may be defined as reaching a fixed number of bidders placing a hid by a fixed amount of time prior to the bidding deadline. For instance, the extension triggering condition can be a minimum of one bidder placing a bid within 24 hours prior to the bid deadline. An amount of time extension may also be defined (step 75), such as a bid deadline extension of 24 hours. If an extension triggering condition(s) is not met, the bidders are preferably allowed to place bids until the bid deadline is reached (step 76). Once the bid deadline is reached, a winner is preferably declared (step 78).

If an extension triggering condition is met, the bid deadline is preferably extended (step 80) by the pre-defined amount of time extension from step 75. The system preferably continues to receive bids (step 82) until either an extension triggering condition is met or the extended bid deadline has lapsed, whichever is earlier.

If the format includes a Universal Last Call feature, one or more item categories are preferably defined (step 84) and the items currently being auctioned are preferably grouped according to the categories just defined (step 86). At step 88, the program is preferably configured to determine whether the format should include the Last Call feature. If the format does not include the Last Call feature, then the program proceeds to execute step 65. If the format includes the Last Call feature, the program proceeds to step 72.

### Another Auction Method Embodiment

Referring now to FIG. 5B, the auction program may alternatively be configured to execute the steps shown in flowchart 90. At step 92, the system preferably obtains information about the property from the seller and inputs them into a database. Next, at step 94, the system preferably determines whether to offer the Last Call feature. If the Last Call feature will not be offered, the system preferably displays the auctions that are available for the users for bidding (step 96). The system determines whether the bid deadline has passed (step 98). If the deadline has not passed, the system may allow the users to place their bids (step 100). If the deadline has passed, the system preferably ends the auction (step 102).

If the Last Call feature will be offered, the Last Call extension criteria that would trigger a bid deadline extension are preferably selected (step 104). For example, one of the criteria may be if a bid is received within 24 hours prior to the bid deadline. Next, the system preferably determines whether to offer the Universal Last Call feature (step 106). If the Universal Last Call feature will be offered, categories of the lots being auctioned are preferably defined, and the properties being auctioned are preferably grouped into their respective categories (step 107). The hid deadlines for all the properties in a selected category may then be adjusted so they are all the same (step 108).

After step 108 or if the Universal Last Call feature will not be offered, the system preferably displays the auctions that are available for the users for bidding (step 110). The system determines whether the bid deadline has passed (step 112). If the deadline has passed, the system preferably ends the auction (step 114). If the deadline has not passed, the system may allow the users to place their bids (step 116).

Each time a bid is placed, the system preferably checks whether the Last Call extension criteria has been met (step 118) and whether the Universal Last Call feature is on (step 120). If the Last Call extension criteria has been met and the Universal Last Call feature is on, the bid deadlines for all the properties in the selected category may then be adjusted so they are all the same (step 122). The auction preferably continues and re-executes the steps starting at step 110. If the Last Call extension criteria has been met but the Universal Last Call feature is not on, only the bid deadline for the property for which the bid was placed is extended (step 124, and the auction resumes to step 110.

### Website Showing Embodiments of the Present Invention

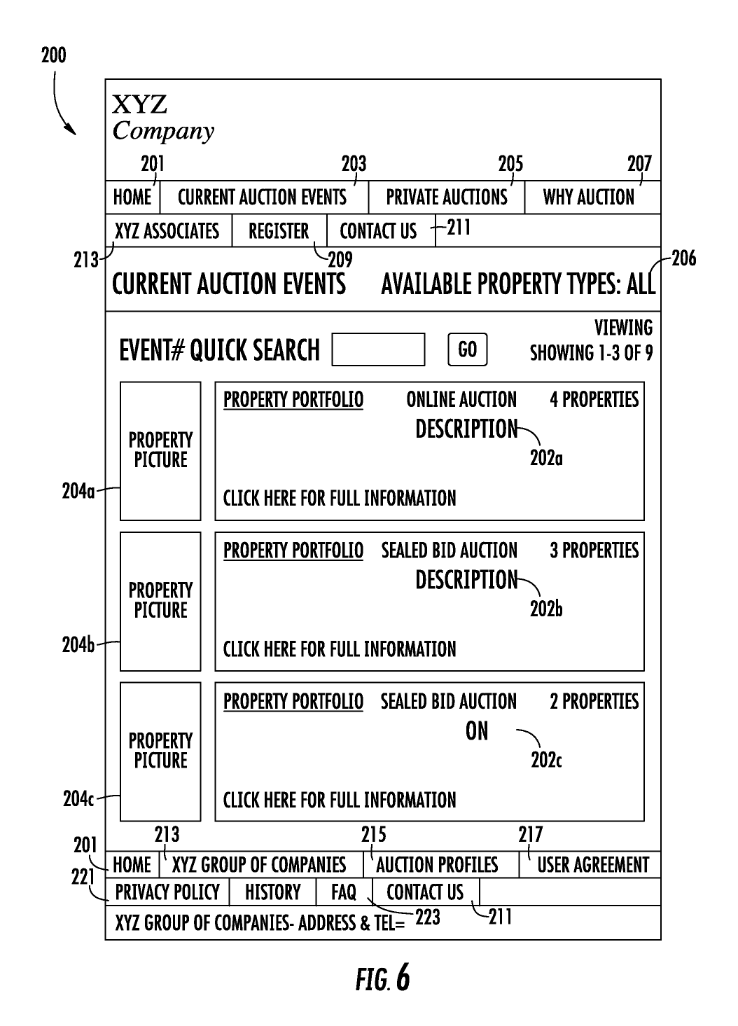

The embodiments of the present invention may also be illustrated by way of demonstration web pages as shown in FIGS. 6 through 9. FIG. 6 shows a web page 200 displaying brief descriptions of current auction events, including a list of various property portfolios that are being auctioned 202a, 202b, and 202c, pictures of sample properties from the property portfolios 204a, 204b, and 204c. The webpage 200 may include links to the home page 201, current auction events page 203, private auctions page 205, a description page of the auctions conducted on the website 207, a registration page 209, and a contact us page 211. The webpage 200 may further include links to the auctioneer information page 213, profile pages of properties being auctioned 215, user agreement page 217, privacy policy page 221, and a frequently asked question page 223. It is noted that an auction event may include multiple properties being auctioned, or it may include a single property. The teachings of the present invention are equally applicable to both chattel property and real estate property. The current auctions events page 200 preferably includes a search tool 206 which allows potential bidders to find a specific property or groups of properties of interest by using various filters such as location, type, size, ownership and value. The search tool 206 may be used to find specific chattel property based on the attributes of the chattel. From the current auction events page 200, a potential bidder can navigate to any of the sealed bid or online auctions on the web site.

If an auction event includes multiple properties, a description of the various properties including their general locations, property types and sizes may be displayed. A single picture of one of the properties from each property portfolios 204a, 204b, or 204c may also be displayed. By clicking on the picture 204a, 204b, or 204c or the general property description 202a, 202b, or 202c, the potential bidder is preferably taken to the property portfolio page 208 shown in FIG. 7. FIG. 7 illustrates a portfolio of properties associated with a single seller or other common feature. This is known as the property portfolio page 208. When multiple properties are owned by a single entity, or have similar or common features, they are preferably grouped as a portfolio since potential buyers may have an interest in the properties according to their common features. The property portfolio page 208 preferably also includes the same search tool 206 just like the search tool 206 in the current auction events page 200, which allows potential bidders to find specific properties of interest by using various filters such as location, type and price.

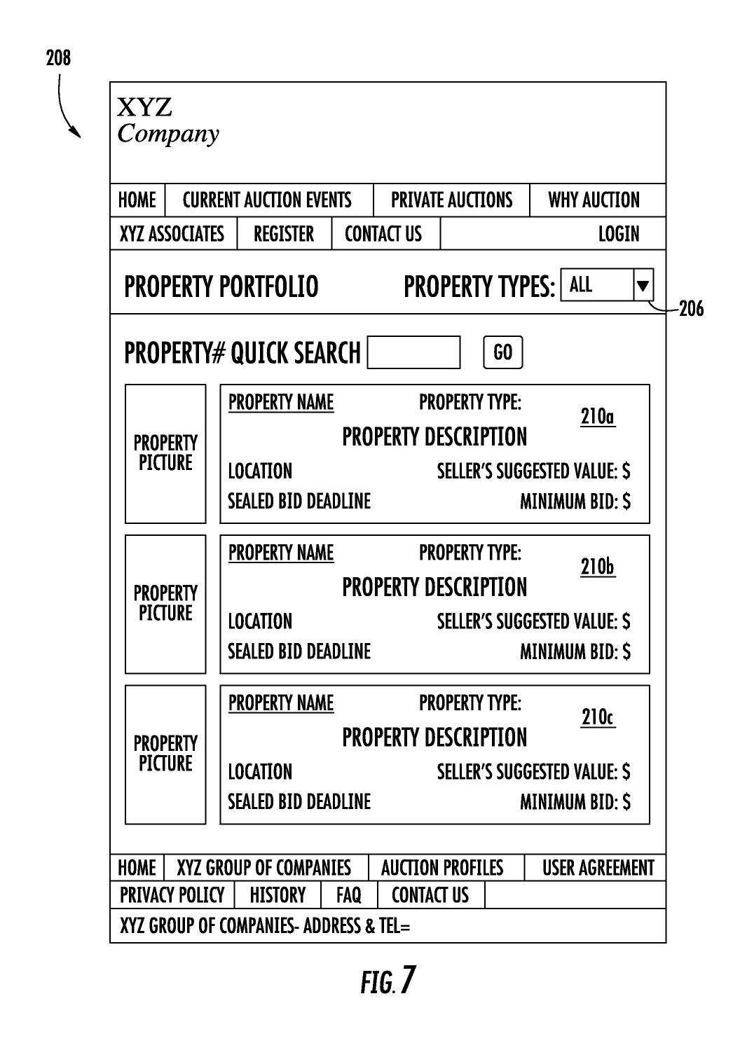

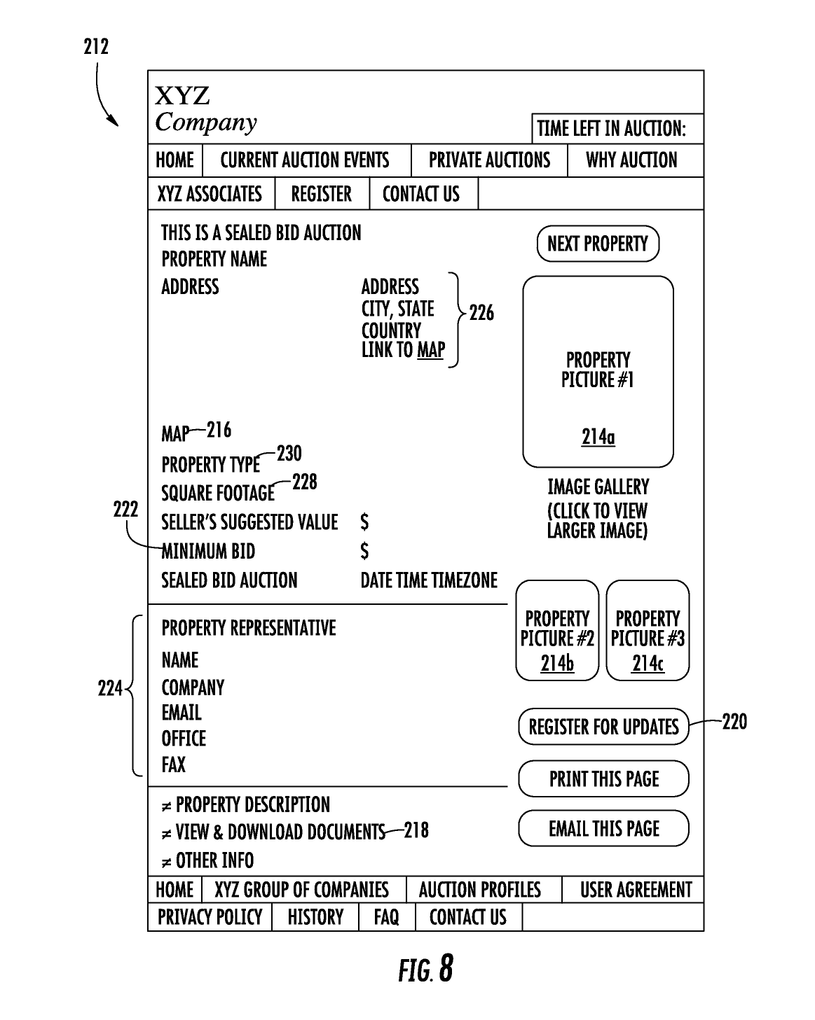

By selecting an individual property from the portfolio page 210a, 210b, or 210c, prospective bidders are preferably directed to its property profile page. Two embodiments of the property profile page are shown in FIGS. 8 and 9. The property profile page shown in FIG. 8 is preferably for properties auctioned through a sealed bid auction format. The property profile page shown in FIG. 9 is preferably for properties auctioned through a public or non-sealed auction. It is noted that the same property profile page 212 may be shown if the auction event includes a single property or chattel property.

Referring now to FIG. 8, the property profile page 212 preferably includes the property's pictures 214a, 214b and 214c, location 226, property type 230 and size 228. Interested bidders may view photographs and click on the view and download documents link 218 to download information on a particular property including maps, government reports, tax information, plot plans and obtain financing information by viewing the particular property profile page. Interested bidders who have not registered under the website are preferably requested to register by completing a brief data sheet. A registration link 220 may be provided. Once they have registered, they may log-in with a specific username and password and view or download documents related to the property or chattel property in question. Other information, such as the minimum bid increment 222 and contact information of the property representative 224 who is responsible for conducting tours and viewing of that specific property, and other detailed information on the property can be found on the individual property profile page 212.

Referring now to FIG. 9, the individual property profile page 228 for a property auctioned through a non-sealed auction format is preferably similar to the property profile page 212 shown in FIG. 8 except that the current highest bid 230 and the bid increment 232 are shown.

### Media Tracking Feature of the Present Invention

Property portfolio and property profile pages can also be accessed directly from the URL address listed in various print and electronic advertisements. When a property, chattel property or group of properties is advertised for sale, the advertisement preferably contains a URL that will direct an interested party directly to a property portfolio page in the event multiple properties are being advertised and to a property profile page in the event a single property is being advertised. Information is preferably imbedded in the URL regarding the auction property or auction chattel property and the media that published the advertisement. The website preferably assimilates information regarding the number of times a particular URL is accessed or “hit” and generates a media tracking report.

The media tracking report preferably compares the price of an advertisement with the number of “hits” resulting from that advertisement. It preferably also records information about bidders that have signed in from a particular advertisement, such as whether they are principals or brokers. In this manner, the website may be able to assign a cost per respondent value to an individual media. In the case where respondents register on the website, the cost per respondent value can then be analyzed through the several stages of the auction process. The stages may be defined as seven tracking milestones and may include: (1) Prospect ‘Hit’ to website; (2) Prospect Registration; (3) Registrant physical visitation to Property; (4) Registrant prequalifies for mortgage financing (residential Website only); (5) Bidder places Sealed Bid and submits same along with a Bid Deposit; (6) Bidder places Online Bid (only if the sale progresses from the sealed bid format to the online bid format); and (7) Winning Bidder is announced.

As an illustration, if an advertisement costs $6000 and receives 600 responses, each response is valued at $10. If 60 of the 600 responses register on the website, each registration is valued at $100. If 6 of the 60 registrations, bid on a property, each bid is valued at $1000, and if 1 of those six is the winning bidder, they are valued at $6000. By employing this method, the website can quickly determine the cost effectiveness of a particular advertisement and can amend future media schedules in response.

### One Embodiment of a Bidding Process of the Present Invention

In one embodiment of the bidding process of the present invention, to submit an initial sealed bid or place a subsequent online electronic bid, interested bidders may be required to register on the website. A written or a sealed hid may be submitted to the seller's agent on or before the bid deadline by utilizing the approved bid form, which can be downloaded from the property profile page. The completed bid form can then be sent or delivered to the seller's agent. Additionally, the bid preferably is required to be at or above the amount established by the seller as the lowest allowable bid (minimum bid) as set forth on the property profile page. When submitting the bid form, interested bidders preferably are required to include a bid deposit in the form of a deposit payment. For example, a bid deposit might be the highest of $30,000, or two percent (2%) of the amount of the bid. A winning bidder's deposit is preferably credited toward the purchase price of the property. For all unsuccessful bidders, the bid deposit may be returned either in full or less a nominal escrow fee within a designated period from the time a winning bidder is determined.

The seller preferably retains the right to change the auction format from a sealed bid auction to a live online electronic auction at any time. During a sealed bid format, the details of a property for sale are preferably disclosed without revealing any bidder identity, bid amounts or bid history. Upon declaring an online auction, all interested bidders or parties are preferably allowed to view the amount of the highest sealed bid by means of a bid history update located on the property profile page. Once the bidding format has moved from sealed bid to online bid, potential bidders who have not previously submitted a bid may still do so provided they submit their initial bid on a bid form and submit it to the seller's agent along with the required bid deposit.

Each time a new electronic hid is placed during an online auction, the bidder's identity, the amount of the bid, and the date and time that the bid was received by the website is preferably published in the bid history section. All bidders and other interested parties are encouraged to frequently review the bid history during the online auction in order to receive updates on the highest bid. No additional bid deposit is preferably required when placing subsequent bids during an online auction.

### Embodiment of a Bid Extension or Last Call Feature of the Present Invention

Upon declaring an online auction, electronic bids may be tendered up to the bid deadline using a bid button on the property profile page. Bids may be tendered up to the bid deadline subject to a possible “Last Call” extension. If no bid is submitted within the designated period of time (usually, but not limited to 24 hours) prior to the published bid deadline, the bidding will preferably be closed. It should be noted that access to the bid history section may only be available from the property profile page after a non-sealed online auction has been declared.

If a non-sealed online auction bid or a predetermined threshold number of auction bids is submitted within a pre-determined time before the published bid deadline, the deadline will preferably be extended for another pre-determined period of time, which will be referred to as “Last Call.” In the event another new bid or a predetermined threshold number of bids is received before the new bid deadline, the deadline will preferably again be extended for an additional predetermined period. The new bid deadline will preferably continue to be extended in this manner until no new valid bid is received prior to the bid deadline. When no new valid bid is received, the bidding will preferably be closed.

For Example, if a published online auction bid deadline is initially set for Apr. 22, 2005 at 17:00, and a new bid is submitted on Apr. 22, 2005 at 11:02, then the new bid deadline will preferably be extended to Apr. 23, 2005 at 17:00, assuming that the designated time period is 24 hours. Further, if another new bid is received on Apr. 23, 2005 at 16:34, the bid deadline will once again be preferably extended to Apr. 24, 2005 at 17:00. The new bid deadline will preferably continue to be extended in this manner until no new bid is received within the designated period of time (e.g., 24 hours) of the bid deadline. Bidding will preferably only be closed when no new bids are received within 24 hours of the bid deadline.

If a potential bidder has not previously submitted a bid on a property subject to a Last Call, an initial bid may still be made on the property. However, this initial hid must preferably be delivered on a bid form along with a proper bid deposit. Each time a new bid is submitted during the “Last Call,” the bidder's identity, the amount of the bid, and the date and time that the bid was submitted are preferably published in the bid history. All bidders and potential bidders are preferably advised to review the bid history frequently during the Last Call. No additional bid deposit may be required when placing a bid during the Last Call.

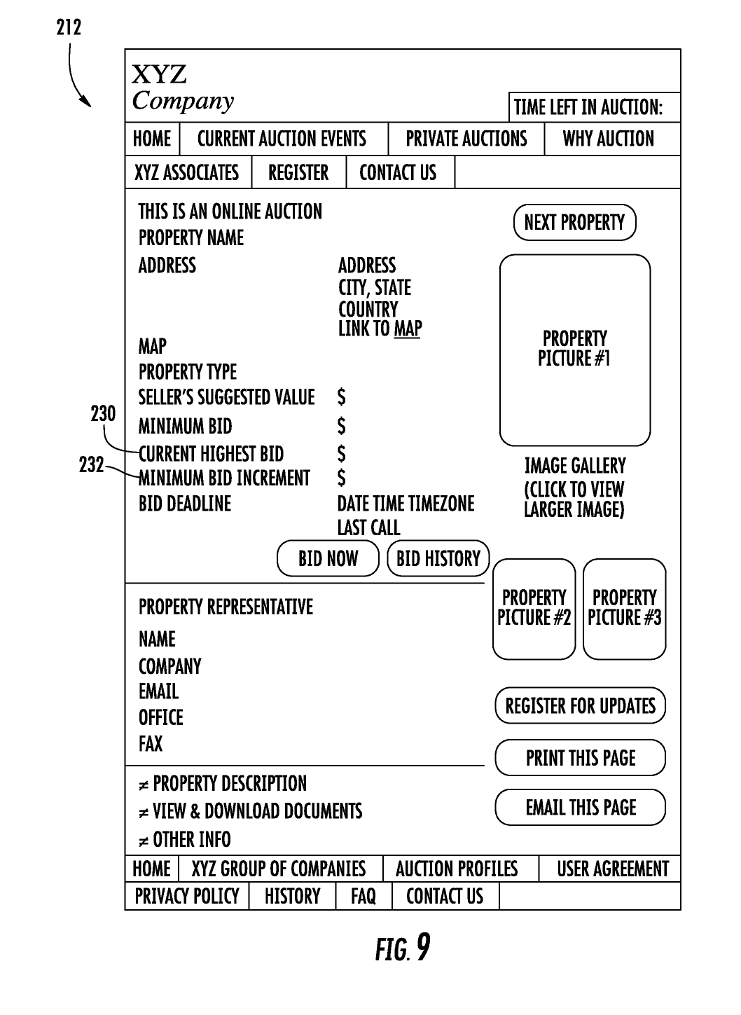

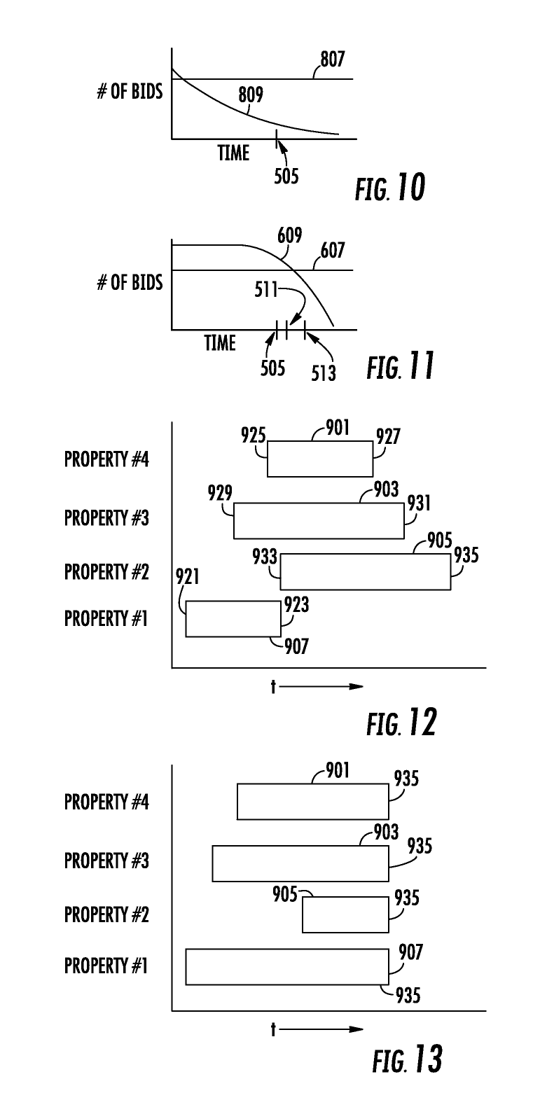

FIG. 10 illustrates a situation when the bidding bid deadline is not extended because insufficient bidding activity had occurred. The bidding activity may be insufficient when the bidding falls below a predetermined number of bidding or the bidding falls below one bid in a predetermined period. A graph shows the number of bids being received as a function of time and the predetermined threshold number 807 of bids which is required to extend the bidding deadline. The predetermined threshold number 807 may be a single bid or may be multiple bids. When bidding opens, the number of bids received exceeds the predetermined threshold number as shown by line 809. As time progresses, the rate of bids received diminishes below the predetermined threshold number so that as the original bidding deadline 505 approaches, the number of bids 809 being received are below the predetermined threshold number 807. Consequently, the bidding deadline remains as the original bidding deadline with no extension.

FIG. 11 illustrates that the number of bids received 609 exceeds the predetermined threshold number 607 at or prior to the original bidding deadline 505. Consequently, the bidding deadline is extended to a first bidding deadline 511. At the first bidding deadline 511, the number of received bids 609 still exceeds the predetermined threshold number of bids 607 and the bidding deadline is extended to a second bidding deadline 513. As the second bidding deadline 513 is approached, the number of received bids 609 has dropped below the predetermined threshold number 607. The second bidding deadline 513 is not extended, and the winning hid is preferably determined at the second bidding deadline 513.

### Embodiment of a Universal Last Call Feature of the Present Invention

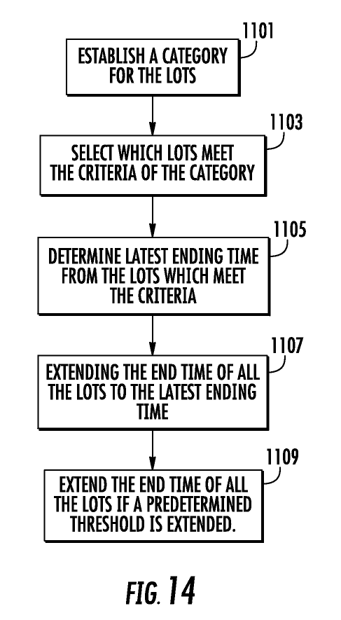

FIGS. 12 and 13 illustrate an embodiment of a feature of the present invention referred to as “Universal Last Call.” Typically, a lot to be auctioned may have a start time and an end time that is typically different than any other lot to be auctioned. As discussed above, because of the varying start and end times, a bidder may have to make a choice which is less than optimal. With the present invention, all of these lots grouped in a category can have their auction end time adjusted to be the same end time. In this manner, the bidder can intelligently choose which lot suits the bidder's needs the best based upon the choices and prices.

FIG. 12 illustrates four real estate properties 901, 903, 905, and 907 having different auction beginning times and end times. The auction of property 907 may include the earliest start time 921 and the earliest end time 923. If a bidder was interested in property 907, property 905, property 903 and property 901, the bidder would have to decide whether or not to bid on property 907, without knowing the bidding on property 905, property 903, and property 901.

The auction of property 901 has a start time 925 and an end time 927. The auction of property 901 has an end time 927 which may end before the end time 931 of the auction for the property 903 and before the end time 935 of the property 905. Consequently, the bidder would have to decide whether or not to bid on property 901, and forgo bidding on property 903, property 905 and property 907. After the auction end time 927 of property 901, the bidder would have given up the opportunity to bid on property 901. The auction for the property 903 has the next earliest ending time 931, and to bid on this property 903, the bidder has lost the opportunity to hid on property 901 and property 907. Furthermore, by bidding for property 903, the bidder may lose the opportunity to bid on property 905. Finally, by bidding on property 905, the bidder may have lost the opportunity to bid on property 901, property 903 and property 907. As a result the bidder may have lost a good opportunity by not bidding on any of these properties. To aid in solving this problem, in FIG. 13 the end time for the auction for properties or chattels that have been predetermined to be of a specific classification is extended so that the end time for the auction occurs substantially simultaneously so that the bidder can view the bids for each property or chattel and make a selection which is tailored for his desired property or chattel.

From our previous example, the property 905 has the latest ending time 935 with the auction. Consequently, the ending time for the properties and 901, 903 and 907 may be extended to substantially coincide with the ending time 935 of the auction for property 905 (FIG. 13). As a result, the bidder can participate in all the auctions and realize the real estate property or chattel which meets his needs and desires. Furthermore, since the number of bidders for each of the real estate properties or chattels is increased, the amount of the bid for a given real estate property may substantially increase or the amount for all the real estate properties may substantially increase. The simultaneous adjustment of the end time for all the auctions of a category to substantially a single end time may be known as “Universal Last Call.”

### Last Call Feature Combined With Universal Last Call Feature

In certain embodiments, the teachings of the Last Call may be combined with the teachings of the Universal Last Call. More particularly, after the simultaneous adjustment of the end time for all the auctions of the category, the adjusted end time may be extended based upon the number of bids that are being placed in accordance with the teachings of Last Call. As the lots are determined by the seller to be of the same classification, the auction deadlines for all the lots are preferably set to be the same (see FIG. 13). Bidder A may decide that he only wishes to buy 1 lot in an auction, but there are a number of similar lots, any one of which would be suitable for Bidder A. Bidder A may place his initial bid on lot 901, which turns out to be the most popular lot. Bidders B, C and D may also bid on lot 901, driving up that price. Bidder A, who is outbid, now determines that lot 907 is a better deal at its lower price, and places his bid on lot 907 in the last moments of the auction. However as the auction is in “Last Call” the auction is extended. And because all of the relevant lots are classified together and are in “Universal Last Call,” all of the auctions' deadlines are extended simultaneously to the same new auction deadline. The extra time allows Bidder B to place a bid on lot 907, and now Bidder A has the time to look at which lot (if any) he now wishes to bid on.

The simultaneous extension of the auction deadlines may continue several times until no more bids are received in the pre-determined period before the deadline that would otherwise cause the auctions to extend. At this time the seller may be contented because the maximum price is reached for each lot, and the bidders may be happy because they were not denied any opportunity to bid on whichever lot they wished.

FIG. 14 illustrates the steps of an embodiment of a method that incorporates both the Last Call and Universal Last Call features of the present invention. In step 1101, a category for the lots is preferably established by defining a set of criteria, and in step 1103, the lots that meet the criteria are preferably selected. In step 1105, the latest ending time is preferably determined from the lots which meet the criteria, and in step 1107, the end time of all the selected lots is preferably extended to the latest end time. In step 1109, the end time of all the selected lots is extended if a predetermined threshold of rate of bids is exceeded.

In a traditional auction, a first lot may come up for bidding for a first predetermined time period while a second lot may be offered for bidding for a second predetermined time period. In those cases, the first predetermined time period does not end at the same time as the second predetermined time period. A bidder is forced to make choices on which lot to buy. At any given time, there may be several desirable lots which may interest the buyer. Typically, the bidding for these lots does not expire at a single time. Consequently, the bidder does not know what the price will be for a lot that expires in the future. The bidder may be interested in a first lot which expires at a first time and a second lot which expires at a second time which may be after the first time. The bidder may find the second lot more desirable than the first lot but because the bidding for the second lot has not expired, there is uncertainty as to the price for the second lot. Under these circumstances, the bidder may wish that he had purchased the first lot because now the bidder has not purchased either the first lot or the second lot. It can now be realized that with the certain embodiments of the present invention, auction items that have similar characteristics may be grouped together and auctioned so that they are scheduled to end at the same time to minimize leaving the bidders feeling that they are forced to make immediate choices on which items to buy during an auction. Certain embodiments provide a method for extending the deadline for bids of a plurality of lots which correspond to property in an auction. The method may include establishing a category for the lots to be auctioned, selecting the lots which meet the criterion of the category for the lots to be auctioned, determining the latest ending time from the lots which meet the criteria of the category, and extending the end time of all the lots to be substantially the latest ending time which had been determined.

Certain embodiments also provide a method of auctioning real estate properties or chattel property, wherein said auctioning can be conducted in various electronic bidding formats, including sealed, non-sealed or live, with Last Call feature, with Universal Last Call feature, and various combinations thereof. Yet certain embodiments further provide a method of auctioning real estate properties or chattel property comprising handling last minute online bidding extensions.

Certain embodiments of the present invention provide an Internet web site dedicated to advertising, marketing, and auctioning real estate property and chattel property wherein interested bidders may log in, view and download specific property information such as photographs, maps, government reports, tax information, and plot plans. They may then obtain property specific financing information by viewing a web page dedicated to each individual property, wherein such property profile pages contain all the information necessary for an interested party to become familiar with the property and to place a sealed or electronic, online bid to purchase the property. Yet certain embodiments of the present invention further provide a password protected web site area, called private auction events, where potential bidders may only view the above described property information and place property bids by invitation of the seller or the seller's agent.

Certain embodiments of the present invention provide an Internet website is used as an auction forum dedicated to advertising, marketing, and auctioning real estate, and contains details on properties for sale in the United States and throughout the world. Real estate and chattel property owners may post a property for sale on the site. The site then advertises individual properties for sale in a wide variety of media. Each individual media outlet is preferably assigned an individual media code. Each advertisement preferably contains a unique uniform resource locator address (URL), which specifies the particular property for sale, and the media code associated with that advertisement. By typing in the Internet address contained in an advertisement, a potential bidder is directed to a property profile page on the auction website. In addition, the auction website records the media code associated with the advertisement.

The website may then generate a media tracking report to gauge the efficacy of a particular advertisement against others. The website can then attach a cost per response valuation to every type of advertising in an auction marketing campaign. Advertisements that are inexpensive and generate a large number of potential bidders can be preferred over advertisements that generate little interest. In addition, a cost per respondent value can be tracked through the auction process.

Although preferred embodiments of the present invention have been shown and described, various modifications and substitutions may be made thereto without departing from the spirit and scope of the invention. For instance, the properties that can be auctioned may be a residential or commercial real estate or a chattel property; the auction may be in sealed format; and, the predefined category may be based on a price range, geographical area, neighborhoods, schools, or age of the item being auctioned. The predefined category may further be based on ownership. For instance, if the properties being auctioned belong to one owner or related owners, they may be grouped into one category such that when the Universal Last Call feature is triggered, their hid deadlines are adjusted to be the same. The auction may be conducted over an electronic communications network between a server computer operating the auction web site, and the plurality of computers may be operated by bidders, which may be located in different locations, provided they can connect to the Internet. The server computer and each computer operated by bidders may have network interfaces, and via the Internet, each bidder's computer may communicate with the server computer. In the same way, the server computer may communicate with each bidder's computer. The server computer may operate the web site and linked databases that bidders' computers access to learn details of the lots for auction. The server computer may receive bids from bidders' computers on specific lots, process those bids to update bidding information on the appropriate lots, and update bidders' computers with the new high bid information. Accordingly, it is to be understood that the present invention has been described by way of illustration and not limitation. The invention is capable of other embodiments and of being practiced and carried out in various ways. The invention is not limited in its application to the details of the construction and to the arrangement of the components set forth in the above description or as illustrated in the drawings.

What is claimed is:

1. A method for conducting an auction over a computer network, the computer network being connectable to a plurality of computers, the method comprising:
a. storing on a network accessible storage device a description of a lot to be auctioned;
b. scheduling via a network accessible computer a bid deadline;
c. transmitting via the network accessible computer the bid deadline to the computers connected to the computer network;
d. allowing a bid to be placed from one of the computers connected to the computer network before the bid deadline;
e. defining a bid deadline extension triggering condition dependent on at least the number of bids being placed before the bid deadline;
f. determining whether the extension triggering condition has been met; and
g. extending the bid deadline when the extension triggering condition is met.

2. The method of claim 1, further comprising:
a. storing on the network accessible storage device descriptions of a plurality of lots to be auctioned;
b. defining a plurality of lot categories; and
c. grouping each of the plurality of lots to be auctioned into their categories, wherein the bid deadline set from the step of scheduling via a network accessible computer a bid deadline applies to an entire lot category.

3. The method of claim 2 wherein when the extension triggering condition is met, the bid deadline for the entire lot category is extended.

4. The method of claim 2 further comprising finding common characteristics among the plurality of lots to be auctioned and defining the plurality of lot categories based on the common characteristics.

5. The method of claim 4, wherein a characteristic is dependent on a price range for the plurality of lots.

6. The method of claim 4, wherein a characteristic is dependent on geographical locations of the plurality of lots.

7. The method of claim 4, wherein a characteristic is based on whether the lots are owned by a common owner.

8. The method of claim 1, wherein the lot is chattel.

9. The method of claim 1, wherein the lot is real estate property.

10. A method of conducting an auction over a computer network, the computer network being connectable to a plurality of computers, the method comprising:
a. storing on a storage device connected to the computer network descriptions of various lots to be auctioned;
b. defining lot characteristics for at least one lot category;
c. selecting from the lots to be auctioned lots that fit the predefined lot characteristics;
d. auctioning over the computer network the lots that fit the predefined lot characteristics; and
e. scheduling a bid deadline for accepting bids, the bid deadline for each of the selected lots being the same.

11. The method of claim 10, further comprising:
a. defining at least one condition that would trigger the extension of the bid deadline to be dependent on the number of bids transmitted through the computer network;
b. determining whether the condition has been met; and
c. extending the bid deadline when the condition has been determined to be met, the extended hid deadline being the same for each of the selected lots.

12. The method of claim 10, wherein the lots to be auctioned are real estate properties.

13. The method of claim 10, wherein the lots to be auctioned are chattel.

14. The method of claim 10, wherein a lot characteristic is that the lot is located in a predefined geographical boundary.

15. The method of claim 10, wherein a characteristic is based on whether the lots are owned by a common owner.

16. The method of claim 10, wherein the condition that would trigger the extension of the bid deadline is dependent on both the number of bids transmitted through the computer network and the time they are transmitted.

17. A method for conducting an auction over a communications network, the method comprising:
a. providing on a network-accessible computer a plurality of lots to be auctioned;
b. providing on the network-accessible computer at least one category of lots;
c. establishing on a computer program at least one criterion for the category of the lots to be auctioned;
d. selecting using the computer program at least one lot that meets the at least one criterion;
e. auctioning at the same time a plurality of lots that are selected to be in one category via the communications network;
f. setting a specific bid deadline for each of the plurality of lots that are selected to be in one category;
g. defining a condition that would require the bid deadline for at least one of the plurality of lots to be extended;
h. determining using the computer program and based on the condition whether to extend the bid deadline for at least one of the plurality of lots; and
i. if the bid deadline for the at least one of the plurality of lots is determined to be extended, extending all the bid deadlines of all the plurality of lots in the same category to be substantially the extended bid deadline which had been determined.

18. The method of claim 17, the method further including the step of auctioning the lots in accordance with the extended bid deadline.

19. The method of claim 17, wherein the category corresponds to the age of the real estate.

20. The method of claim 17, wherein the category corresponds to residential real estate.
